(19) United States
(12) Patent Application Publication
(10) Pub. No.: US 2010/0172305 A1
(43) Pub. Date: Jul. 8, 2010

(54) COMMUNICATION RESOURCE MANAGEMENT

(76) Inventors: Stanley VITEBSKY, Morristown, NJ (US); Yang Yang, Morris Plains, NJ (US)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 12/350,258

(22) Filed: Jan. 8, 2009

(51) Int. Cl. H04W 72/04; H04L 12/66

(52) U.S. Cl. 370/329; 370/352

(57) ABSTRACT

An exemplary method of controlling usage of a communication resource (120) comprises organizing a selected bandwidth of a communication resource including a plurality of resource blocks (RBs) (31-62) into a hierarchical arrangement (122) wherein the RBs are contiguous to each other at a lowest level of the arrangement. Nodes (1-30) at higher levels of the arrangement (122) each correspond to a plurality of the RBs in a dependent, related position relative to each node, respectively. At least one RB is assigned to a selected user of the communication resource (120) based upon a current assignment of at least one other RB to maintain a maximum possible number of contiguous unassigned RBs.

### FIELD OF THE INVENTION

This invention generally relates to telecommunications.

### DESCRIPTION OF THE RELATED ART

Communication systems are in widespread use in various contexts. Wireless communications have been increasing in capability and popularity. There are increasing options in line-based communications, also. With increased demand and competition, communication providers are always striving to provide enhanced services to subscribers. Doing that depends, in part, on managing the communication resources available for conducting subscriber communications including scheduling use of the resources and controlling the amount of signaling traffic.

Next generation wireless systems such as 802.16e, WiMAX, UMTS Long Term Evolution LTE) and CDMA2000 EV-DO Revision C Ultra Mobile Broadband (UMB) are based on orthogonal frequency multiple division access (OFDMA). A fully scheduled resource access control scheme is used on the uplink and downlink for OFDMA. With that, explicit signaling assigns resources to user data transmission. The signaling overhead needed for such assignments can become very bandwidth and power consuming, especially in a scenario in which the system supports a large number of relatively low rate applications such as voice over Internet protocol (VoIP). It is therefore necessary to provide a mechanism to reduce signaling overhead.

In OFDMA communication systems two kinds of resources can become capacity limiting; power and orthogonal dimensions. The latter refers to groups of frequency sub-carriers (i.e., tones) over a certain number of time-domain symbol periods that are referred to as tiles, resource blocks or OFDMA base nodes. The smallest scheduling unit such as a resource block is transmitted over the duration of one time slot or frame.

In general, different tones belonging to a tile or resource block may be scattered across an entire frequency band of a particular communication resource. In such a case, the transmission will experience a diversified channel and interference on each sub-carrier.

Given that hybrid automatic repeat request (HARQ) techniques are employed to increase system capacity, transmissions are interlaced in order to allow ACK/NAK feedback from the receiver. The dimension is therefore defined by the pair of tile and HARQ interlace. The number of dimensions allocated to a user is determined by the relationship between the packet format and the required application data rate. In general, the required application data rate should be less than or equal to the amount of data that could be transmitted using assigned packet format divided by the average HARQ transmission time of the packet.

Encoder packet transmission occurs using multiple HARQ interlaces repeating every certain number of frames and having a fixed maximum allowed number of sub-packet retransmissions. The tile-interlace resource assignment is valid for the duration of each encoder packet transmission. For low rate applications, such as voice, it is desirable to assign the resources for longer durations corresponding to talk spurt activity to reduce signaling overhead related to resource assignment.

There is a need for effectively scheduling communication resources in a manner that reduces signaling overhead and facilitates effective and efficient use of the communication resource.

### SUMMARY OF THE INVENTION

An exemplary method of controlling usage of a communication resource comprises organizing a selected bandwidth of a communication resource including a plurality of resource blocks (RBs) into a hierarchical arrangement wherein the RBs are contiguous to each other at a lowest level of the arrangement. Nodes at higher levels of the arrangement each correspond to a plurality of the RBs in a dependent, related position relative to each node, respectively. At least one RB is assigned to a selected user of the communication resource based upon a current assignment of at least one other RB to maintain a maximum possible number of contiguous unassigned RBs.

An exemplary communication system comprises a communication resource having a bandwidth and including a plurality of resource blocks (RBs) arranged into a hierarchical arrangement wherein the RBs are contiguous to each other at a lowest level of the arrangement. Nodes at higher levels each correspond to a plurality of the RBs in a dependent, related position relative to each node, respectively. A resource assignment controller is configured to assign at least one of the RBs to a selected user of the communication resource based upon a current assignment of at least one other RB to maintain a maximum possible number of contiguous unassigned RBs.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a wireless communication system.

FIG. 2 schematically illustrates a hierarchical arrangement of a communication resource.

FIG. 3 is a schematic, cross-sectional view taken along the lines 3-3 in FIG. 2.

### DETAILED DESCRIPTION

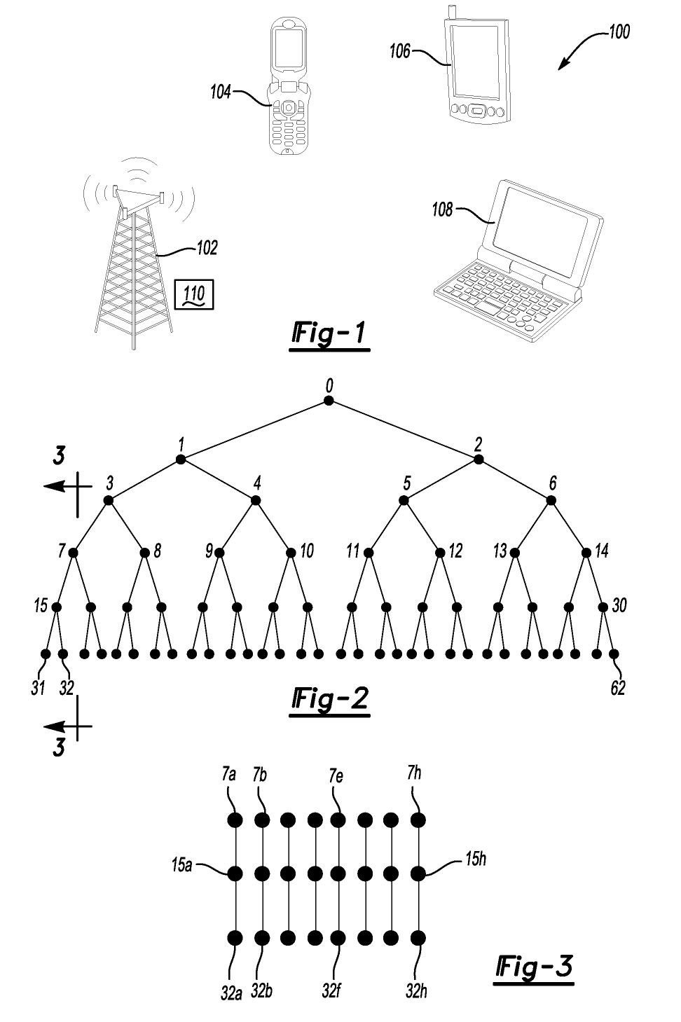

FIG. 1 schematically shows selected portions of a wireless communication system 100. In this example, a base station 102 communicates with one or more mobile stations 104, 106 and 108. The communication resource used in this example comprises a selected bandwidth of an over-the-air interface between the base station 102 and the mobile stations. In another example, the communication resource comprises a line-based communication link.

The base station 102 includes a resource assignment controller 110 that is configured to assign the communication resource to the mobile stations 104, 106, 108 on an as-needed basis. In some instances the assignment is on a packet transmission interval basis while in other instances a persistent assignment is made for relatively lower rate applications such as voice communications. One such application for which persistent assignments are used is voice over Internet protocol (VoIP) communications.

The communication resource 120 is schematically illustrated at in FIG. 2. The communication resource comprises a selected amount of bandwidth available for communications including the base station 102. In one example, the bandwidth is approximately 5 MHz. The communication resource 120 comprises a plurality of resource blocks (RBs) (alternatively referred to as tiles or base nodes, for example). The RBs are shown at a lowest level of the hierarchical arrangement 122 of FIG. 2. The RBs are labeled 31-62 in this example because there are 30 potentially available tiles for scheduling transmissions over the communication resource. Each tile in this example comprise a plurality of tones.

The hierarchical arrangement 122 of FIG. 2 includes a plurality of nodes 1-30 at higher levels in the arrangement than the RBs 31-62. The nodes each have a plurality of RBs associated with them in a dependent position as can be appreciated from the drawing. The nodes 1-30 allow for scheduling or assigning a plurality of RBs by signaling the node identifier(s) instead of signaling the entire group of RBs that depend from the corresponding node(s).

FIG. 2 schematically shows how the example communication resource 120 is arranged in a frequency domain. The communication resource 120 has another dimension that can be schematically represented in a direction into the page of the drawing. The illustration of FIG. 3 shows a selected portion of the arrangement as seen taken along the lines 3-3 in FIG. 2. Only a portion of the arrangement 122 is shown in FIG. 3 for simplicity and discussion purposes. It is possible to think of the illustration of FIG. 2 being repeated multiple times in layers extending into the page for example.

Each RB has a plurality of interlace layers associated with it. In the example of FIG. 3, the RB 32 has 8 interlace layers 32a-32h. The number of interlace layers and the total number of RBs may vary depending on a particular communication resource or a communication system within which the resource is used.

The illustration of FIG. 3 includes a plurality of layers of nodes 15a-15h and 7a-7h, for example, that allow for assigning corresponding groups of dependent RB interlace layers by signaling node identifiers. Other node strategies can be used as those skilled in the art who have the benefit of this description and known resource arrangement techniques will appreciate.

The resource assignment controller 110 assigns at least one RB to a selected user (e.g., mobile station 104, 106, 108) in a manner that depends on which of the RBs are currently assigned. The assignment strategy of this example maintains a maximum possible number of contiguous unassigned RBs. Keeping as many unassigned contiguous RBs as possible facilitates making persistent resource assignments of groups of contiguous RBs more consistently and with relatively lower signaling overhead. For example, keeping as many contiguous RBs unassigned as possible maximizes the ability to signal a single node identifier to make a resource assignment when multiple RBs are needed. If the resource becomes segmented (e.g., the currently assigned and currently unassigned RBs are interspersed among each other), it becomes necessary to signal the individual RB identifiers if more than one RB is needed for a particular assignment. Additionally, if the resource is segmented, the assignment including non-contiguous RBs introduces increased chances of varying channel and interference conditions for a particular transmission. Therefore, keeping as many contiguous RBs unassigned as possible decreases signaling overhead and improves the consistency of similar channel and interference conditions across the RBs of a particular transmission.

In one example, the resource assignment controller 110 selects the RB or RBs to assign to a user by determining how many RBs are needed. If only one RB (possibly including several or all interlaces a-h corresponding to a single RB) is needed, the controller 110 determines the current status of the RBs. The controller in one example starts from one side of the arrangement 122 and proceeds in a direction toward an opposite side (e.g., from left to right according to the drawing). Once an available RB is identified, the controller 110 assigns that RB to the user.

When more than one RB is needed, the controller 110 in one example determines the level of node that corresponds to the appropriate number of dependent RBs. The controller 110 begins on one side of the arrangement 122 and progresses in a direction toward the opposite side determining along the way which, if any, of the nodes at that level has unassigned RBs that would allow the corresponding node identifier to be used to signal the resource assignment. Keeping as many contiguous RBs unassigned as possible increases the likelihood that such a node will exist at any given time.

In one example, the controller 110 is configured to prioritize assignments such that all of the interlace layers associated with a RB are assigned to a single user for one assignment before multiple RBs are assigned to that user. In another example, the controller 110 prioritizes assignments of RBs (or nodes) such that any persistent assignments are made to RBs or nodes having a common parent node with other RBs (or nodes) that are currently assigned for persistent assignments. Given the longer times typically occupied by persistent assignments for lower rate applications compared to higher rate applications, using this prioritization tends to keep more contiguous RBs available for shorter-term assignments for the higher rate applications.

The controller 110 in one example evaluates the current assignment of the RBs of the communication resource 120 to identify any currently unassigned RBs between currently assigned RBs. In some cases, the controller 110 will reassign a user from at least one other RB to a corresponding number of the identified unassigned RBs. This reassignment will decrease the amount of segmenting of the communication resource 120 and increase the amount of contiguous unassigned RBs.

The assignment techniques described above are useful for new call requests, new data transmission requests, reassignments of ongoing calls or handover operations, for example.

The example assignment techniques have several associated features including facilitating persistent resource assignments without fragmenting or segmenting the resource between assigned and unassigned RBs. Keeping as many contiguous unassigned RBs as possible facilitates easier, more efficient signaling and persistent resource assignments can be made to contiguous RBs for more consistent channel and interference conditions for a transmission.

The preceding description is exemplary rather than limiting in nature. Variations and modifications to the disclosed examples may become apparent to those skilled in the art. The scope of legal protection given to this invention can only be determined by studying the following claims.

We claim:

1. A method of controlling usage of a communication resource, comprising the steps of:
organizing a selected bandwidth of a communication resource including a plurality of resource blocks (RBs) into a hierarchical arrangement wherein the RBs are contiguous to each other at a lowest level of the arrangement with nodes at higher levels each corresponding to a plurality of the RBs in a dependent, related position relative to each node, respectively; and
assigning at least one RB to a selected user of the communication resource based upon a current assignment of at least one other RB to maintain a maximum possible number of contiguous unassigned ones of the RBs.

2. The method of claim 1, wherein the hierarchical arrangement has a first side at one end of the bandwidth and a second side at an opposite end of the bandwidth and the method comprises determining a level in the arrangement corresponding to the number of RBs required to be assigned to the selected user;
progressing in a direction from the first side of the arrangement at the determined level toward the second side;
identifying the first unassigned node or RB at the determined level; and
assigning any RB corresponding to the identified node or RB to the selected user.

3. The method of claim 2, comprising performing the determining, progressing, identifying and assigning for a new call.

4. The method of claim 2, comprising performing the determining, progressing, identifying and assigning for a reassignment of an existing call.

5. The method of claim 1, comprising
evaluating the arrangement to identify currently unassigned RBs between currently assigned RBs; and
reassigning a user of at least one other currently assigned RB to a corresponding number of the identified currently unassigned RBs to increase a number of contiguous unassigned RBs.

6. The method of claim 1, comprising
grouping RBs for persistent assignments together by assigning as many contiguous RBs sharing a common parent node as possible.

7. The method of claim 6, comprising
prioritizing an additional persistent RB assignment to at least one RB that shares a parent node with another RB currently assigned to a persistent assignment and wherein the parent node is at a lowest possible level in the arrangement.

8. The method of claim 1, wherein the arrangement comprises a plurality of interlace layers corresponding to each of the RBs and at least some of the assigning comprises assigning as many interlace layers for one of the RBs as possible to a single user.

9. The method of claim 8, comprising prioritizing assignments to all interlace layers corresponding to one of the RBs for one user before assigning more than one RB to the one user.

10. The method of claim 1, wherein the RBs are used for Voice over Internet Protocol assignments.

11. A communication system, comprising:
a communication resource having a bandwidth and including a plurality of resource blocks (RBs) arranged into a hierarchical arrangement wherein the RBs are contiguous to each other at a lowest level of the arrangement with nodes at higher levels each corresponding to a plurality of the RBs in a dependent, related position relative to each node, respectively; and
a resource assignment controller configured to assign at least one of the RBs to a selected user of the communication resource based upon a current assignment of at least one other RB to maintain a maximum possible number of contiguous unassigned ones of the RBs.

12. The system of claim 11, wherein the hierarchical arrangement has a first side at one end of the bandwidth and a second side at an opposite end of the bandwidth and the controller is configured to
determine a level in the arrangement corresponding to the number of RBs required to be assigned to the selected user;
progress in a direction from the first side of the arrangement at the determined level toward the second side;
identify the first unassigned node or RB at the determined level; and
assign any RB corresponding to the identified node or RB to the selected user.

13. The system of claim 12, wherein the controller is configured to assign the RBs for a new call.

14. The system of claim 12, wherein the controller is configured to assign the RBs for a reassignment of an existing call.

15. The system of claim 11, wherein the controller is configured to
evaluate the arrangement to identify currently unassigned RBs between currently assigned RBs; and
reassign a user of at least one other currently assigned RB to a corresponding number of the identified currently unassigned RBs to increase a number of contiguous unassigned RBs.

16. The system of claim 11, wherein the controller is configured to group RBs for persistent assignments together by assigning as many contiguous RBs sharing a common parent node as possible.

17. The system of claim 16, wherein the controller is configured to prioritize an additional persistent RB assignment to at least one RB that shares a parent node with another RB currently assigned to a persistent assignment and wherein the parent node is at a lowest possible level in the arrangement.

18. The system of claim 11, wherein the arrangement comprises a plurality of interlace layers corresponding to each of the RBs and the controller is configured to assign as many interlace layers for one of the RBs as possible to a single user.

19. The system of claim 18, wherein the controller is configured to prioritize assignments to all interlace layers corresponding to one of the RBs for one user before assigning more than one RB to the one user.

20. The system of claim 11, wherein the RBs are used for Voice over Internet Protocol assignments.
